(19) United States
(12) Patent Application Publication
(10) Pub. No.: US 2019/0101858 A1
(43) Pub. Date: Apr. 4, 2019

(54) IMAGE FORMING APPARATUS AND CONTROL METHOD

(71) Applicant: KONICA MINOLTA, INC., Tokyo (JP)

(72) Inventors: YOSHITERU KAWAKAMI, Tokyo (JP); YASUO SHIOKAWA, Tokyo (JP); TAKAHIRO OKUBO, Midori-ku Yokohama-shi Kanagawa (JP)

(21) Appl. No.: 16/150,697

(22) Filed: Oct. 3, 2018

(30) Foreign Application Priority Data
Oct. 4, 2017 (JP) 2017-193943

(51) Int. Cl. G03G 15/00

(52) U.S. Cl. CPC G03G 15/6561; G03G 15/657; G03G 15/70

(57) ABSTRACT

An image forming apparatus conveys a sheet in a transfer position of an image by a transferer and transfers the image to the sheet, and the image forming apparatus includes: a detector that detects positions of side ends of the sheet; and a hardware processor that: determines presence or absence of a one side loop on the basis of the positions of the side ends detected by the detector; and performs predetermined control related to solving of the one side loop when the hardware processor determines that there is the one side loop.

### CROSS REFERENCE TO RELATED APPLICATION

The present application claims priority under 35 U.S.C § 119(e) to Japanese Application No. 2017-193943, filed Oct. 4, 2017 the entire content of which is also incorporated herein by reference.

### BACKGROUND

### Technological Field

The present invention relates to an image forming apparatus and a control method.

### Description of the Related Art

In recent years, a multifunctional image forming apparatus that also functions as a printer, a scanner, a copier, a facsimile, and the like has been widely used. In the image forming apparatus, at the time of image formation, a sheet is conveyed from a sheet feeding unit or a reversing path to a transferer, but in some cases, due to mechanical factors of the apparatus or the like, the sheet is one-sided in a direction (hereinafter, sometimes referred to as a sheet width direction) orthogonal to a conveyance direction. In the case where printing processing is performed in a state in which the sheet is one-sided as described above, there is a problem that a forming position of an image with respect to the sheet deviates from a proper position.

Therefore, in order to accurately align the image and the sheet in consideration of the sheet being one-sided, registration swing correction of correcting the one-sided of the sheet by holding the sheet by the registration roller and swinging in a sheet width direction is performed.

For example, JP 2013-91563 A discloses an image forming apparatus in which a registration roller is disposed on an upstream side of an image forming position, a line sensor is disposed in a position that is a downstream side of the registration roller and is an upstream side of the secondary transfer roller, and a sheet is swung in a sheet width direction on the basis of an amount of being one-sided of the sheet detected by the line sensor, so that the sheet being one-sided is corrected.

According to conventional techniques including JP 2013-91563 A, a registration roller swings before a tip end of a sheet reaches a secondary transfer roller, to align a position of side ends of the sheet. However, generation of a one side loop (a distorted state where there is a difference in front and back in a loop shape) on a sheet in between a transferer and a fixer cannot be prevented merely by swinging before the sheet reaches the secondary transfer roller. When a one side loop is generated on a sheet between the transferer and the fixer, image defects such as wrinkles and rubbing occur, which causes a problem of degradation in image quality.

### SUMMARY

An object of the present invention is to suppress degradation in image quality even when a one side loop is generated on a sheet.

To achieve the abovementioned object, according to an aspect of the present invention, there is provided an image forming apparatus that conveys a sheet in a transfer position of an image by a transferer and transfers the image to the sheet, and the image forming apparatus reflecting one aspect of the present invention comprises:

a detector that detects positions of side ends of the sheet; and

a hardware processor that:

determines presence or absence of a one side loop on the basis of the positions of the side ends detected by the detector; and

performs predetermined control related to solving of the one side loop when the hardware processor determines that there is the one side loop.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram schematically showing an image forming apparatus according to an embodiment;

FIG. 2 is an explanatory diagram showing swing processing of a sheet by a registration roller;

FIG. 3 is a block diagram schematically showing a configuration of a control system of the image forming apparatus of FIG. 1;

FIG. 4 is a flowchart showing processing of controlling swing operation of the registration roller;

FIG. 5 is a diagram showing an example of data storage of a swing control table;

FIG. 6A to FIG. 6C are diagrams showing an example of a method of determining presence or absence of a one side loop;

FIG. 7 is a diagram showing a configuration in which two position detection sensors are arranged in a sheet width direction; and

FIG. 8 is a diagram showing a configuration in which two position detection sensors are arranged in a sheet conveyance direction.

### DETAILED DESCRIPTION OF EMBODIMENTS

Hereinafter, one or more embodiments of the present invention will be described in detail with reference to the drawings. However, the scope of the invention is not limited to the disclosed embodiments.

[Configuration of Image Forming Apparatus 100]

First, a configuration of an image forming apparatus 100 in the present embodiment will be described.

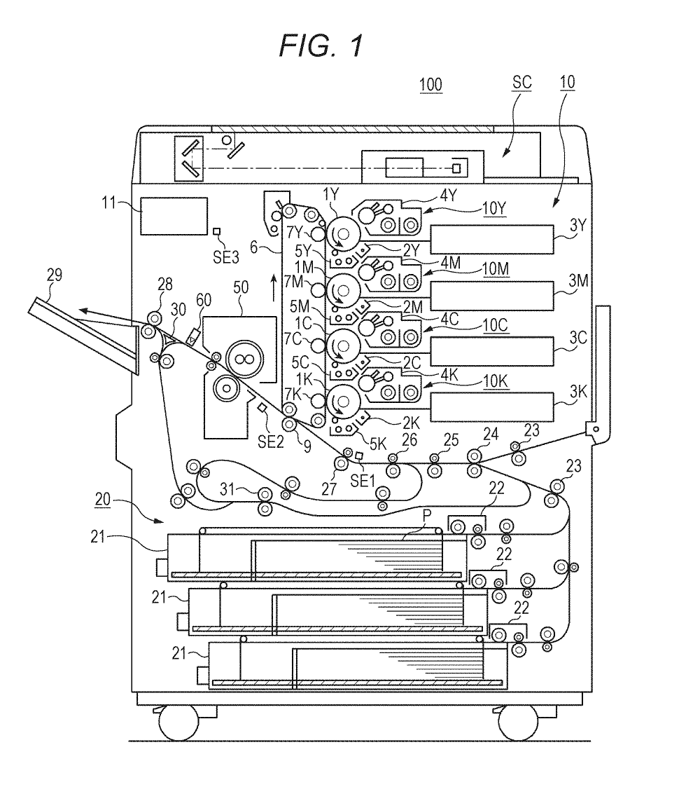

FIG. 1 is a configuration diagram schematically showing the image forming apparatus 100 according to the present embodiment. This image forming apparatus 100 is an electrophotographic image forming apparatus 100 such as a copying machine and forms a full color image by arranging a plurality of photoconductors in a longitudinal direction so that the photoconductors face with one intermediate transfer belt, and is a so-called tandem type color image forming apparatus.

The image forming apparatus 100 mainly includes a document reading device SC, an image forming unit 10, a fixing device 50, an image reading unit 60, and a controller 11, and these are housed in one casing.

The document reading device SC scans and exposes an image of a document by an optical system of a scanning exposure device and reads a reflected light by a line image sensor, thereby obtaining an image signal. This image signal is subjected to processing such as A/D conversion, shading correction, compression, and the like, and then input to the controller 11 as image data. Note that the image data input to the controller 11 is not limited to the image data read by the document reading device SC but may be, for example, data received from a personal computer or another image forming apparatus connected to the image forming apparatus 100 by a communication unit 13.

The image forming unit 10 includes four sets of image forming units 10Y, 10M, 10C, 10K, an intermediate transfer belt 6, a secondary transfer roller 9, and the like. The image forming units 10Y, 10M, 10C, 10K include the image forming unit 10Y for forming an image of yellow (Y), the image forming unit 10M for forming an image of magenta (M), the image forming unit 10C for forming an image of cyan (C), and the image forming unit 10K for forming an image of black (K).

The image forming unit 10Y includes a photoconductive drum 1Y and a charging unit 2Y, an optical writing unit 3Y, a developing device 4Y and a drum cleaner 5Y disposed around the photoconductive drum 1Y. Similarly, the image forming units 10M, 10C, 10K include photoconductive drums 1M, 1C, 1K, and charging units 2M, 2C, 2K, optical writing units 3M, 3C, 3K, developing devices 4M, 4C, 4K and drum cleaners 5M, 5C, 5K disposed around the photoconductive drums 1M, 1C, 1K.

Surfaces of the photoconductive drums 1Y to 1K are uniformly charged by the charging units 2Y to 2K, and latent images are formed on the photoconductive drums 1Y to 1K by scanning exposure by the optical writing units 3Y to 3K. The developing devices 4Y to 4K visualize latent images on the photoconductive drums 1Y to 1K by developing with toner. As a result, a toner image of a predetermined color corresponding to any one of yellow, magenta, cyan, and black is formed on each of the photoconductive drums 1Y to 1K. The toner images formed on the photoconductive drums 1Y to 1K are sequentially transferred to a predetermined position on the rotating intermediate transfer belt 6 by primary transfer rollers 7Y, 7M, 7C, 7K.

The toner image formed of each color transferred onto the intermediate transfer belt 6 is transferred by the secondary transfer roller 9 to a sheet P to be conveyed at a predetermined timing by a sheet conveyance unit 20 described later. The secondary transfer roller 9 is a pressure contact member that forms a nip unit (hereinafter referred to as a “transfer nip unit”) by being disposed in pressure contact with the intermediate transfer belt 6.

The sheet conveyance unit 20 conveys the sheet P in accordance with a conveyance path of the sheet P. The sheet P is stored in a sheet feeding tray 21, and the sheet P accommodated in the sheet feeding tray 21 is taken in by a sheet feeding unit 22 and sent out to the conveyance path. Alternatively, the sheet P is accommodated in a sheet feeding tray included in an external sheet feeding tray (not shown) connected to the image forming apparatus 100 via external sheet feeding ports 81, 82, and the sheet P included by the sheet feeding device is fed from the sheet feeding device to the image forming apparatus 100 via the external sheet feeding port 81 or 82, and is sent out to the conveyance path. For example, a long sheet is fed from the external sheet feeding device to the image forming apparatus 100 via the external sheet feeding port 81 or 82.

In this conveyance path, a plurality of conveyance means for conveying the sheet P are provided on an upstream side of the transfer nip unit. Each of the conveyance means includes a pair of pressure-contacted rollers, and at least one of the rollers is driven to rotate through a driving mechanism mainly including an electric motor to convey the sheet P. The pair of rollers composing individual conveyance means is configured so that a state between the rollers can be switched between a pressure contact state and a separated state.

In the present embodiment, intermediate conveyance rollers 23 to 25, a loop roller 26 and a registration roller 27 are provided as conveyance means from the upstream side to the downstream side of the conveyance path of the sheet P. Wide range of configurations formed of a pair of rotating members such as combination of belts, or combination of a belt and a roller, in addition to the configuration formed of a pair of rollers, can be adopted as the conveyance means.

In such a conveyance path, the sheet P fed from the sheet feeding tray 21 or the sheet feeding tray of the sheet feeding device is sequentially conveyed by the plurality of intermediate conveyance rollers 23 to 25 and the loop roller 26 provided from the upstream side to the downstream side, and travels along the conveyance path. When the tip end of the sheet P approaches to the registration roller 27, the sheet P to be conveyed by the intermediate conveyance rollers 23 to 25 and the loop roller 26 abuts to the registration roller 27 in a rotation stopped state, and the loop roller 26 continues to rotate for a predetermined time, so that a loop is formed on the sheet P. Bending of the tip end of the sheet P is corrected (skew correction) by the action of this loop formation.

Next, when the registration roller 27 starts rotating at a predetermined timing so as to be synchronized with the toner image carried by the intermediate transfer belt 6, the intermediate conveyance rollers 23 to 25 and the loop roller 26 are switched from the pressure contact state to the separated state. That is, after the intermediate conveyance rollers 23 to 25 and the loop roller 26 have transitioned to the separated state, the sheet P is conveyed only by the registration roller 27. This registration roller 27 performs swing processing described later while conveying the sheet P as a swing roller, to convey the sheet P to the intermediate transfer belt 6 as an image carrier and the transfer nip unit of the secondary transfer roller 9 as the transferer.

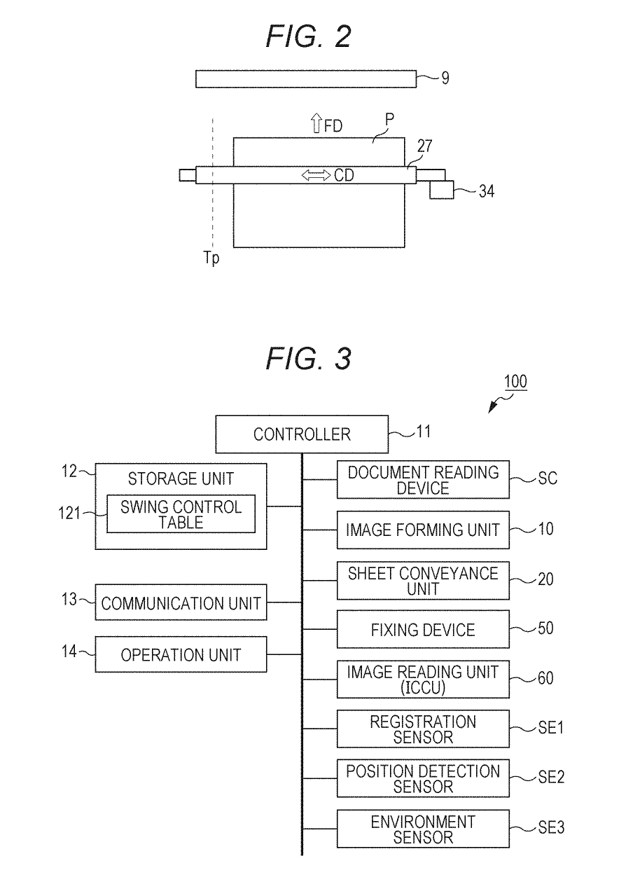

FIG. 2 is an explanatory diagram showing swing processing of the sheet P by the registration roller 27. The registration roller 27 is configured to be capable of swinging in a sheet width direction CD (direction orthogonal to the sheet conveyance direction (sub scanning direction) FD). A driving mechanism 34 mainly including an electric motor is coupled to the registration roller 27, and the registration roller 27 can move in the sheet width direction CD with a predetermined home position as a starting point by being driven by the driving mechanism 34.

The registration roller 27 can move along the sheet width direction CD in accordance with a passage period during which the sheet P passes through the registration roller 27, to move the sheet P conveyed along the sheet width direction CD (swing processing). As a result, the registration roller 27 adjusts the conveyance position of the sheet P in the sheet width direction CD so as to be aligned with the position of the toner image to be transferred. Here, a position through which a side end of the sheet P should pass in the sheet width direction CD is referred to as a target position Tp. The target position Tp is a position in which, it is expected that, when the side end of the sheet P passes through the position in the sheet width direction CD, a positional relationship between the sheet P and the toner image is optimum (for example, the center in the width direction of the sheet P and the center in the width direction of the toner image coincide with each other). The registration roller 27 adjusts the conveyance position of the sheet P in the sheet width direction CD so that the side end of the sheet P is in the target position Tp. The position of the toner image in which the positional relationship between the sheet P and the toner image is optimum is referred to as an optimum image position.

A registration sensor SE1 and a position detection sensor SE2 are provided on the conveyance path, and operation of the registration roller 27 is controlled by the controller 11 on the basis of the detection results in these sensors.

In the conveyance path, the registration sensor SE1 is disposed between the registration roller 27 and the loop roller 26. The registration sensor SE1 detects arrival of the tip end of the sheet P at the detection position of the registration sensor SE1 (the position that is forward for predetermined distance of the registration roller 27). The detection result of the registration sensor SE1 is used for detection of a rotation start timing of the registration roller 27 and the like.

On the conveyance path, the position detection sensor SE2 is provided on the downstream side of sheet conveyance direction FD of the secondary transfer roller 9 (that is, between the secondary transfer roller 9 and the fixing device 50) and on a non-image surface side of the sheet P. The position detection sensor SE2 is a detector that detects the position of the side end of the sheet P in the sheet width direction CD. The position detection sensor SE2 is a line sensor (for example, a CCD line sensor) in which a plurality of light receiving elements are linearly arranged along the sheet width direction CD. The detection result of the position detection sensor SE2 is output to the controller 11, and is used for determination of swing control information of the registration roller 27 in the swing processing, or the like.

The fixing device (fixer) 50 is a device that applies fixing processing to the sheet P on which the toner image is transferred, that is, the sheet P sent out from the transfer nip unit, and includes, for example, a pair of fixing members (for example, a pair of rollers) and a heater for heating one or both of the fixing members. In the conveyance process of the sheet P, the fixing device 50 fixes the toner image on the sheet P through the action of the pressing by the pair of fixing members and the heat of the fixing members.

The sheet P subjected to the fixing processing by the fixing device 50 is read by the image reading unit (ICCU) 60 and then discharged to a sheet discharge tray 29 attached to an outer side surface of the housing by a sheet discharge roller 28. In the case where an image is formed also on a back surface of the sheet P, the sheet P on which the image formation on the sheet surface has been completed is read by the image reading unit 60 and then conveyed by a switching gate 30 to a reversing roller 31 that is in a downside. The reversing roller 31 holds the rear end of the conveyed sheet P, then reverses the sheet P by feeding the sheet P in reverse, and sends out the sheet P to a sheet refeeding conveyance path. The sheet P sent out to this sheet refeeding conveyance path is conveyed by a plurality of sheet refeeding conveyance means and causes the sheet P to return to the transfer nip unit via the registration roller 27. Note that the sheet discharge roller 28, the switching gate 30, the reversing roller 31 and the sheet refeeding conveyance means also compose the above-described sheet conveyance unit 20.

The image reading unit 60 includes, for example, a linear image sensor (for example, a CCD line sensor), an optical system, a light source, and the like, reads the sheet P on which the toner image is transferred, and outputs the obtained read image to the controller 11. In the present embodiment, the image reading unit 60 can measure the color of the toner image on the sheet P, but the image reading unit 60 is not particularly limited thereto as long as the image reading unit 60 can recognize at least an area of the sheet P and an area of the toner image. In the present embodiment, the image reading unit 60 is disposed on a side that is the downstream side of the fixing device 50 and is a forward side from where the conveyance path is switched by the switching gate 30. However, the disposing position is not particularly limited thereto, as long as the position is on the downstream side of the secondary transfer roller 9 (transfer nip unit), and is a position where both surfaces of the sheet P can be read (reading may be performed for one side at one time). Of course, the image reading unit 60 may be disposed as an optional device, on the downstream side of the image forming apparatus 100.

FIG. 3 is a block diagram schematically showing a configuration of a control system of the image forming apparatus 100 according to the present embodiment.

As shown in FIG. 3, the controller 11 is connected to a storage unit 12, a communication unit 13, an operation unit 14, the document reading device SC, the image forming unit 10, the sheet conveyance unit 20, the fixing device 50, the image reading unit 60, the registration sensor SE1, the position detection sensor SE2, and an environment sensor SE3. The controller 11 includes a CPU, a RAM, and the like. The CPU of the controller 11 reads a system program and various processing programs stored in the storage unit 12, develops the programs in the RAM, and centrally controls the operation of each unit of the image forming apparatus 100 in accordance with the developed programs.

For example, when a job execution command is input by the operation unit 14, the controller 11 executes a job and performs control of forming a toner image on the sheet P on the basis of image data input by the document reading device SC and the communication unit 13. When a job execution command is input by the operation unit 14, the controller 11 performs swing control processing and performs swing control of the registration roller 27 that is executing a job.

The storage unit 12 includes a nonvolatile semiconductor memory, a hard disk drive (HDD), and the like, and stores parameters, data, and the like required in each unit, in addition to the various programs executed by the controller 11.

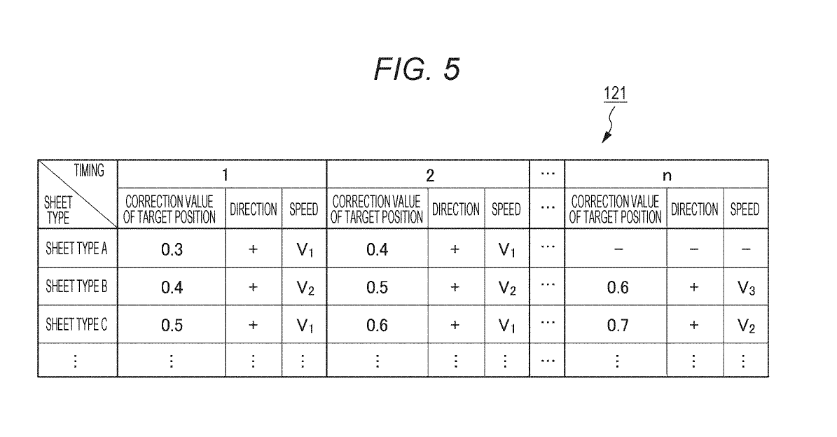

For example, a swing control table 121 (see FIG. 5) is stored in the storage unit 12.

The communication unit 13 includes various interfaces such as a network interface card (NIC), a modulator-demodulator (MODEM), a universal serial bus (USB), and the like, and connects with external devices.

The operation unit 14 outputs various kinds of information set by the user to the controller 11. For example, a touch panel that can perform input operation in accordance with information displayed on the display can be used as the operation unit 14. Through the operation unit 14, a user can set printing conditions, that is, the type (for example, basis weight, size, paper quality, and the like) of the sheet P, the sheet feeding tray to be used, the density of the image, the magnification, the presence or absence of duplex printing. The user can input a job execution instruction and an operation instruction in an adjustment mode through the operation unit 14. The controller 11 can control the operation unit 14 to causes various messages to be displayed to the user via the operation unit 14.

The environment sensor SE3 includes, for example, a temperature sensor, a humidity sensor, and the like, detects the temperature and humidity inside the housing of the image forming apparatus 100, and outputs the detection result to the controller 11.

[Operation of Image Forming Apparatus 100]

Next, the operation of the image forming apparatus 100 in the present embodiment will be described.

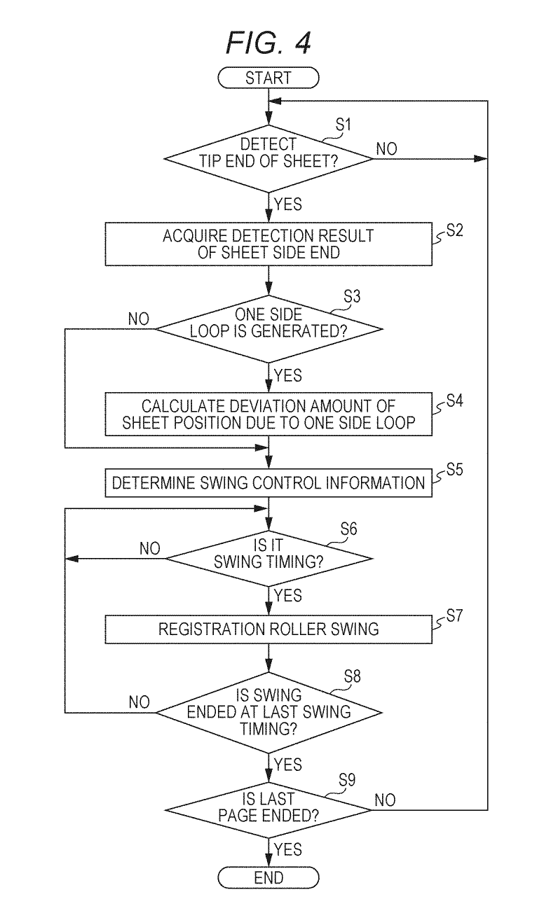

FIG. 4 is a flowchart showing processing of controlling swing operation of the registration roller 27 as an example of predetermined control related to solving of the one side loop generated in the sheet P. The processing shown in this flowchart is performed in cooperation with the controller 11 and the programs stored in the storage unit 12 in response to the job execution instruction from the user.

First, the controller 11 determines whether the tip end of the sheet P is detected by the position detection sensor SE2 (step S1).

When determining that the tip end of the sheet P is detected by the position detection sensor SE2 (YES at step S1), the controller 11 acquires the detection result of the positions of the side ends of the sheet P at a plurality of positions (for example, two points) by the position detection sensor SE2 (step S2). Here, the positions of the side ends of the sheet P includes both the positions of the side ends on the front side and the back side of the sheet P. That is, in step S2, both the position of the side end on the front side of the sheet P and the position of the side end on the back side of the sheet P are acquired.

On the other hand, when the controller 11 determines that the tip end of the sheet P is not detected by the position detection sensor SE2 (NO at step S1), the controller 11 waits until the tip end of the sheet P is detected by the position detection sensor SE2.

Here, the variation in the position of the side end of the sheet P varies depending on the condition related to the sheet conveyance (predetermined condition affecting sheet conveyance). Therefore, the swing control information (the correction value of the target position Tp of the sheet P, the swing direction (+, −) and the swing speed) need to be changed for each condition related to the sheet conveyance, in accordance with the fluctuation in the position of the side end of the sheet P. The conditions related to the sheet conveyance are, for example, the paper type of the sheet P, basis weight, environment (for example, temperature and humidity), sheet size (sheet width, sheet length), and the like. For example, if the paper type is thin paper, since the sheet P is more likely to bend than plain paper or thick paper, it is necessary to make the correction value larger.

In the present embodiment, a table storing the swing control information is stored in the storage unit 12 for each of the above-described conditions related to the sheet conveyance. In other words, the swing control information is set in accordance with the conditions related to the sheet conveyance. FIG. 5 shows an example of a table (swing control table 121) in which swing control information is stored for each type of paper.

Next, the controller 11 determines the presence or absence of the one side loop (that is, whether the one side loop has been generated on the sheet P) on the basis of the detection result by the position detection sensor SE2 acquired in step S2 (step S3). That is, the controller 11 functions as a determinator of the present invention.

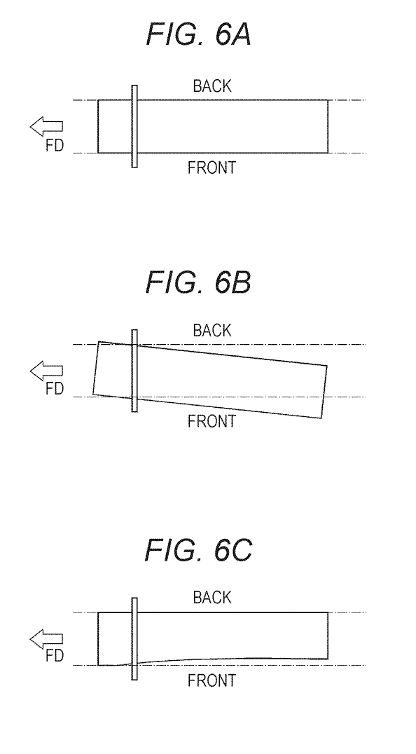

Specifically, the controller 11 determines the presence or absence of the one side loop on the basis of the change (output difference) in the positions of the side ends on the front side and the back side of the sheet P. For example, when the sheet P is conveyed in parallel with the sheet conveyance direction FD and both the position of the side end on the front side and the position of the side end on the back side of the sheet P maintain the same position (see FIG. 6A), the controller 11 determines that there is no one side loop on the sheet P (one side loop has not been generated). When the difference between the position of the side end on the front side of the sheet P and the position of the side end on the back side is constant although the sheet P is conveyed inclined with respect to the sheet conveyance direction FD (see FIG. 6B), the controller 11 determines that there is no one side loop on the sheet P. On the other hand, when the difference between the position of the side end on the front side and the position of the side end on the back side of the sheet P is not constant irrespective of whether the sheet P is conveyed in parallel with the sheet conveyance direction FD (see FIG. 6C), the controller 11 decides that the position of the side end on the front side of the sheet P is relatively deviated from the position of the side end on the back side, and determines that there is the one side loop on the sheet P (one side loop has been generated).

When the controller 11 determines that there is the one side loop on the sheet P (YES at step S3), the controller 11 proceeds to next step S4.

On the other hand, when the controller 11 determines that there is no one side loop on the sheet P (NO at step S3), the controller 11 proceeds to step S5.

Next, the controller 11 calculates a deviation amount of the position of the side end of the sheet P due to the generation of the one side loop on the basis of the detection result by the position detection sensor SE2 acquired in step S2 (step S4).

Next, the controller 11 determines the swing control information of the registration roller 27 at each predetermined swing timing (step S5).

For example, when determining in step S3 that the there is one side loop on the sheet P (YES at step S3), the controller 11 determines the swing control information of the registration roller 27 of each predetermined swing timing on the basis of the deviation amount calculated in step S4 and the predetermined swing control information (swing control table 121). This makes it possible to perform registration swing processing related to solving of the one side loop. As the registration swing processing related to solving of the one side loop, for example, there is processing of swing the registration roller 27 for a predetermined amount corresponding to the deviation amount to change the posture of the sheet, so that the deflection of the sheet P is pulled and the one side loop is solved.

On the other hand, when determining in step S3 that there is no one side loop on the sheet P (NO at step S3), the controller 11 determines the swing control information of the registration roller 27 of each predetermined swing timing on the basis of the detection result by the position detection sensor SE2 acquired in step S2 and the predetermined swing control information (swing control table 121). This makes it possible to perform normal registration swing processing.

In the present embodiment, the registration roller 27 is controlled so as to swing at a plurality of predetermined timings (referred to as swing timing), and each of pieces of the swing control information used in each swing timing (timings 1 to n) is stored in the swing control table 121. Here, in order to accurately write the toner image on the optimum image position of the sheet P, it is preferable that swing control information used at each swing timing (timings 1 to n) is stored in the swing control table 121, for each sheet type, for each basis weight, for each environment, for each sheet size, or a combination thereof.

The swing control table 121 is stored in the storage unit 12 as described above, so that the swing control information can be appropriately determined in accordance with each condition.

Next, the controller 11 determines whether the swing timing of the registration roller 27 has arrived (step S6). Here, the swing timing is the timing of swinging the registration roller 27. In the present embodiment, for example, a plurality of swing timings are predetermined (for example, at substantially equal intervals), as t1 second, t2 seconds, . . . from the timing when the position detection sensor SE2 detects the tip end of the sheet P.

When determining that the swing timing has arrived (YES at step S6), the controller 11 causes the driving mechanism 34 to swing the registration roller 27 on the basis of the swing control information in accordance with the swing timing determined in step S5 (step S7).

On the other hand, when determining that the swing timing has not arrived (NO at step S6), the controller 11 waits until the swing timing arrives.

Next, the controller 11 determines whether the swing at the last swing timing has ended (step S8). For example, the controller 11 determines whether the swing at the last swing timing has ended on the basis of the sheet size of the sheet P and the elapsed time and the conveyance speed after the position detection sensor SE2 detects the tip end of the sheet P.

When determining that the swing at the last swing timing has ended (YES at step S8), the controller 11 determines whether the transfer to the last page has ended (step S9).

On the other hand, when determining that the swing at the last swing timing has not ended (NO at step S8), the controller 11 returns to step S6, waits for the next swing timing, and repeats the processing of swinging the registration roller 27 when the swing timing is arrived.

Next, when determining that the transfer to the last page has ended (YES at step S9), the controller 11 ends the processing.

On the other hand, when determining that the transfer to the last page is not ended (NO at step S9), the controller 11 returns to step S1.

As described above, the image forming apparatus 100 according to the present embodiment includes the detector (the position detection sensor SE2) that detects the positions of the side ends of the sheet, the determinator (controller 11) that determines the presence or absence of the one side loop on the basis of the positions of the side ends detected by the detector, and the controller 11 that performs predetermined control related to solving of the one side loop when the determinator determines that there is the one side loop.

Therefore, according to the image forming apparatus 100 according to the present embodiment, since the one side loop generated on a sheet can be solved, even when the one side loop is generated on a sheet, image defects such as wrinkles and rubbing can be prevented from being generated and the degradation in image quality can be prevented.

According to the image forming apparatus 100 according to the present embodiment, the image forming apparatus 100 includes a swing roller (registration roller 27) that conveys the conveyed sheet toward the transferer (secondary transfer roller 9). When the determinator determines that there is the one side loop, the controller 11 swings the swing roller on the basis of the position of the side end detected by the detector.

Therefore, according to the image forming apparatus 100 according to the present embodiment, the one side loop generated on the sheet can be solved by using existing registration swing correction, so that an increase in size of the apparatus and an increase in cost can be prevented.

According to the image forming apparatus 100 according to the present embodiment, the image forming apparatus 100 includes the fixer (fixing device 50) that fixes an image transferred to the sheet by the transferer. The detector is disposed between the transferer and the fixer.

Therefore, according to the image forming apparatus 100 according to the present embodiment, since the position detection sensor SE2 can read the image transferred to the sheet by the secondary transfer roller 9, not only the position of the side end of the sheet but also the relationship with the image can be decided, and the deviation amount of the position of the side end of the sheet due to the generation of the one side loop can be calculated more accurately. Therefore, the one side loop generated on the sheet can be solved more reliably, so that degradation in image quality can be suppressed more reliably.

According to the image forming apparatus 100 according to the present embodiment, the detector is a line sensor.

Therefore, according to the image forming apparatus 100 according to the present embodiment, the deviation amount of the position of the side end of the sheet due to the generation of the one side loop can be accurately calculated, so that the one side loop generated on the sheet can be solved more reliably, and degradation in image quality can be suppressed more reliably.

Although the present invention has been specifically described above on the basis of the embodiment according to the present invention, the present invention is not limited to the above-described embodiments, and can be modified within the scope not departing from the gist thereof.

For example, in the above-described embodiment, as an example of the predetermined control related to the solving of the one side loop generated on the sheet P, the processing of controlling the swing operation of the registration roller 27 is exemplified and described. However, the processing is not limited thereto. For example, as another example of the predetermined control related to the solving of the one side loop, processing of correcting the alignment of the fixing device 50 may be performed. In that case, the fixing device 50 may be moved in units of a unit including a fixing roller, a frame for holding the fixing roller, various sensors and the like, or may be moved in units of a pair of rollers included by each unit.

When the alignment of the fixing device 50 is corrected, the controller 11 determines the correction information (correction value and correction direction (+, −)) on the basis of the detection result of the position detection sensor SE2, and corrects the alignment of the fixing device 50 on the basis of the determined correction information.

As described above, the alignment of the fixing device 50 is corrected on the basis of the position of the side end detected by the position detection sensor SE2, so that the one side loop generated on the sheet can be solved by using the existing alignment correction, and thereby, an increase in size and an increase in cost of the apparatus can be prevented.

As another example of the predetermined control related to the solving of the one side loop, processing of causing existence of the one side loop and a method of solving the one side loop to be displayed on the operation unit (display) 14 may be performed.

As described above, the existence of the one side loop and the method of solving the one side loop are displayed on the operation unit 14, so that the user can manually solve the one side loop, and thereby, the one side loop can be solved in accordance with user's detailed desire.

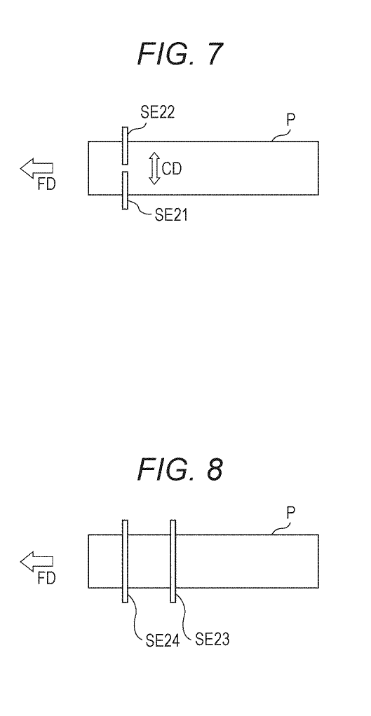

In the above-described embodiment, one position detection sensor SE2 is disposed between the secondary transfer roller 9 and the fixing device 50, but the present invention is not limited thereto. Any configuration may be adopted as long as at least the positions of both ends of the side end can be detected. For example, instead of disposing one position detection sensor SE2, as shown in FIG. 7, two sensors of a position detection sensor SE21 (first detector) that detects the position of one (one end) of the side ends of the sheet P, and a position detection sensor SE22 (second detector) that detects the position of another (another end) of the side ends of the sheet P, may be provided. In this case, the position detection sensor SE21 and the position detection sensor SE22 are arranged side by side in the direction orthogonal to the sheet conveyance direction FD (sheet width direction CD).

As described above, the position detection sensor SE21 that detects one position of the side ends of the sheet and the position detection sensor SE22 that detects another position of the side ends of the sheet are provided, and the position detection sensor SE21 and the position detection sensor SE22 are arranged side by side in the direction orthogonal to the sheet conveyance direction FD, and thereby, a desired configuration can be selected from among various configurations in accordance with the structure, cost, and the like in the apparatus, so that the one side loop can be solved by the configuration desired by the user.

A plurality of sensors may be disposed in the sheet conveyance direction FD. FIG. 8 shows a configuration in which the two position detection sensors SE23, SE24 are disposed in the sheet conveyance direction FD.

As described above, a plurality of detectors (position detection sensors SE23, SE24) are disposed in the sheet conveyance direction FD, and thereby, the deviation amount of the position of the side end of the sheet due to the generation of the one side loop can be calculated in time series, so that the one side loop generated on the sheet can be solved more reliably, and degradation in image quality can be suppressed more reliably.

Instead of disposing the position detection sensor SE2 between the secondary transfer roller 9 and the fixing device 50, the position detection sensor SE2 may be disposed at any position where a loop is formed on the sheet P (for example, immediately front of the registration roller 27).

In the above-described embodiment, the position detection sensor SE2 is disposed on the non-image surface side of the sheet P, but the present invention is not limited thereto. That is, the position detection sensor SE2 may be disposed on the image surface side of the sheet P.

As described above, the position detection sensor SE2 is disposed on the image surface side of the sheet, and thereby, image information of the toner image can be acquired, so that the deviation amount of the position of the side end of the sheet due to the generation of the one side loop can be calculated more accurately. Therefore, the one side loop generated on the sheet can be solved more reliably, so that degradation in image quality can be suppressed more reliably.

In the above-described embodiment, the presence or absence of the one side loop is determined on the basis of the detection result by the position detection sensor SE2, but the present invention is not limited thereto. For example, an actuator that is displaced in accordance with the degree of the loop of the sheet P (loop amount), and a photosensor that outputs a detection signal (ON/OFF of loop detection) to the controller 11 in accordance with the displacement of the actuator may be provided, and the presence or absence of the one side loop may be determined on the basis of the output detection signal.

In the above-described embodiment, a color image forming apparatus in which an image formed on the photoconductive drum is primarily transferred to the intermediate transfer roller and the image is transferred from the intermediate transfer roller to the sheet by the secondary transfer roller has been described as an example. However, the present invention is also applicable to a monochrome image forming apparatus in which an image is directly transferred from the photoconductive drum to the sheet by the transfer roller.

In the above-described embodiment, a configuration in which the registration roller 27 swings in the sheet width direction CD when swinging is described as an example, but the present invention is not limited thereto. That is, if the sheet P to be conveyed can be moved along the sheet width direction CD, the registration roller 27 may be configured to swing in a direction other than the sheet width direction CD (for example, a direction deviated by 5° from the sheet width direction CD).

In the above-described embodiment, the case where the swing roller is the registration roller 27 has been described as an example, but the present invention is not limited thereto, and the swing roller may be separate from the registration roller 27, for example.

In the above-described embodiment, an electrophotographic image forming apparatus is described as an example, but the present invention is not limited thereto. For example, the present invention can be applied to an inkjet type image forming apparatus that records an image on a recording medium by ejecting ink from a nozzle to the recording medium and landing the ink in a desired pattern (for example, as an inkjet recording device, a device that ejects ink to be cured by a predetermined energy ray, from a nozzle, irradiates the ejected ink on the recording medium with the predetermined energy ray to cure the ink, and fixes the ink on the recording medium).

In the above description, an example in which a nonvolatile memory, a hard disk, or the like is used as the computer readable medium of the program according to the present invention is disclosed, but the present invention is not limited to this example. As another computer readable medium, a portable recording medium such as a CD-ROM or the like can be applied. A carrier wave is also applied as a medium for providing data of the program according to the present invention via a communication line.

Besides, the detailed configuration and detailed operation of the image forming apparatus can be appropriately changed without departing from the gist of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus that conveys a sheet in a transfer position of an image by a transferer and transfers the image to the sheet,
the image forming apparatus comprising:
a detector that detects positions of side ends of the sheet; and
a hardware processor that:
determines presence or absence of a one side loop on the basis of the positions of the side ends detected by the detector; and
performs predetermined control related to solving of the one side loop when the hardware processor determines that there is the one side loop.

2. The image forming apparatus according to claim 1, further comprising a swing roller that conveys the sheet conveyed to the transferer,
wherein the hardware processor swings the swing roller on the basis of the positions of the side ends detected by the detector when the hardware processor determines that there is the one side loop.

3. The image forming apparatus according to claim 1, further comprising a fixer that fixes the image transferred to the sheet by the transferer,
wherein the hardware processor corrects alignment of the fixer on the basis of the positions of the side ends detected by the detector when the hardware processor determines that there is the one side loop.

4. The image forming apparatus according to claim 1, wherein the hardware processor causes a display to display existence of the one side loop and a method of solving of the one side loop when the hardware processor determines that there is the one side loop.

5. The image forming apparatus according to claim 1, wherein
the detector comprises:
a first detector that detects one position of the side ends of the sheet; and
a second detector that detects another position of the side ends of the sheet, and
the first detector and the second detector are arranged side by side in a direction orthogonal to a conveyance direction of the sheet.

6. The image forming apparatus according to claim 1, wherein the detector is disposed in plural in a conveyance direction of the sheet.

7. The image forming apparatus according to claim 1, further comprising a fixer that fixes the image transferred to the sheet by the transferer,
wherein the detector is disposed between the transferer and the fixer.

8. The image forming apparatus according to claim 1, wherein the detector is disposed on an image surface side of the sheet.

9. The image forming apparatus according to claim 1, wherein the detector is a line sensor.

10. A control method in an image forming apparatus comprising: a transferer that transfers an image to a sheet, and a detector that detects positions of side ends of the sheet,
the control method comprising:
determining presence or absence of a one side loop on the basis of the positions of the side ends detected by the detector; and
performing predetermined control related to solving of the one side loop when it is determined that there is the one side loop.
